(19) United States
(12) Patent Application Publication
(10) Pub. No.: US 2021/0149010 A1
(43) Pub. Date: May 20, 2021

(54) SYSTEMS AND METHODS FOR DETERMINING THE QUALITY OF GEOLOCATION DATA

(71) Applicant: Under Armour, Inc., Baltimore, MD (US)

(72) Inventors: Grant Kovach, Baltimore, MD (US); Adam Reevesman, Baltimore, MD (US); Meng-Ting (Joyce) Chang, Baltimore, MD (US); Michael Mazzoleni, Baltimore, MD (US); Jeffrey Allen, Baltimore, MD (US)

(73) Assignee: Under Armour, Inc., Baltimore, MD (US)

(21) Appl. No.: 16/686,954

(22) Filed: Nov. 18, 2019

(51) Int. Cl. G01S 5/02; G01S 19/20; G01S 5/08

(52) U.S. Cl. CPC G01S 5/021; G01S 19/20; G01S 19/19; G01S 5/08; G01S 5/0263

(57) ABSTRACT

A fitness tracking system includes a receiver to obtain geolocation data. A method is used to determine the quality of the geolocation data by analyzing the dispersion of the geolocation coordinates during the user fitness activity. The geolocation data is used for calculating exercise metrics and displaying fitness activity when the geolocation data quality satisfies the data quality criteria.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

The methods and systems disclosed in this document relate to the field of fitness tracking systems for monitoring user activity and, in particular, to determining the quality of geolocation data associated with a fitness tracking system.

### BACKGROUND

Active individuals, such as walkers, runners, and other athletes commonly use fitness tracking systems to track exercise metrics such as speed and distance traversed during an exercise session. One common type of fitness tracking system obtains geolocation data from a global navigation satellite system to determine the exercise metrics and/or to generate a map to track the fitness activity. In order to improve the user experience of fitness tracking systems, it is desirable to determine the quality of the geolocation data, and to only use that data for calculating exercise metrics and displaying fitness activity when the data quality satisfies the data quality criteria.

### SUMMARY

In accordance with one exemplary embodiment of the disclosure, a fitness tracking system receives geolocation data from a global navigation satellite system. This data may be used to calculate exercise metrics such as speed and distance and/or to display a map of the locations of fitness activity. When the quality of the geolocation data is high, there will be a high degree of confidence in the calculations for the exercise metrics derived from the geolocation data, and there will also be a high degree of confidence associated with the map displayed showing the locations of fitness activity. However, when the quality of the geolocation data is low, then the confidence in the calculations for the exercise metrics derived from the geolocation data will be low, and there will also be a low degree of confidence associated with the map displayed showing the locations of fitness activity. It is therefore desirable to determine the quality of the geolocation data in order to determine whether to use that data for calculating exercise metrics and/or for displaying fitness activity. If the data quality satisfies the data quality criteria, then the geolocation data may be used to calculate exercise metrics such as speed and distance and/or to display a map showing the locations of fitness activity. However, if the data quality does not satisfy the data quality criteria, then the geolocation data will not be utilized to calculate exercise metrics, and a map showing the locations of fitness activity will not be shown. This prevents erroneous fitness activity data from being shown to the user of the fitness tracking system.

According to another exemplary embodiment of the disclosure, a method of operating a fitness tracking system includes assessing the quality of the geolocation data obtained by a fitness tracking system from a global navigation satellite system during a user fitness activity by analyzing the dispersion of the geolocation coordinates received from the global navigation satellite system during the user fitness activity. In this embodiment, higher amounts of dispersion in the geolocation coordinate data increase the confidence in the quality of the geolocation data, while lower amounts of dispersion in the geolocation coordinate data decrease the confidence in the quality of the geolocation data. Therefore, the data quality criteria is based on the dispersion of the geolocation coordinate data received from the global navigation satellite system during the user fitness activity. If the dispersion of the geolocation coordinate data satisfies the data quality criteria, then the geolocation data may be used to calculate exercise metrics such as speed and distance and/or to display a map showing the locations of fitness activity. However, if the dispersion of the geolocation coordinate data does not satisfy the data quality criteria, then the geolocation data will not be utilized to calculate exercise metrics, and a map showing the locations of fitness activity will not be shown.

These and other aspects shall become apparent when considered in light of the disclosure provided herein.

### BRIEF DESCRIPTION OF THE FIGURES

The above-described features and advantages, as well as others, should become more readily apparent to those of ordinary skill in the art by reference to the following detailed description and the accompanying figures in which:

FIG. 1 is a block diagram of a fitness tracking system, as disclosed herein, that includes a monitoring device, a personal electronic device, and a remote processing server;

FIG. 2 is a block diagram of the monitoring device of the fitness tracking system shown in FIG. 1;

FIG. 3 is a block diagram of the personal electronic device of the fitness tracking system shown in FIG. 1;

FIG. 4 is a flowchart illustrating an exemplary method of operating the fitness tracking system shown in FIG. 1;

FIG. 5 is a graph showing the dispersion of geolocation coordinates (longitude and latitude) obtained from a global navigation satellite system during an indoor user fitness activity (treadmill walking). The raw data is shown with the dispersion overlaid on top;

FIG. 6 is a graph showing the dispersion of geolocation coordinates (longitude and latitude) obtained from a global navigation satellite system during an indoor user fitness activity (treadmill running). The raw data is shown with the dispersion overlaid on top;

FIG. 7 is a graph showing the dispersion of geolocation coordinates (longitude and latitude) obtained from a global navigation satellite system during an outdoor user fitness activity (walking). The raw data is shown with the dispersion overlaid on top;

FIG. 8 is a graph showing the dispersion of geolocation coordinates (longitude and latitude) obtained from a global navigation satellite system during an outdoor user fitness activity (running). The raw data is shown with the dispersion overlaid on top;

FIG. 9 is a graph showing the dispersion of geolocation coordinates (longitude and latitude) obtained from a global navigation satellite system during an outdoor user fitness activity (walking) followed by a user error where the user forgets to end the user fitness activity at the end of the workout. The raw data is shown with the dispersion overlaid on top; and

FIG. 10 is a histogram graph the shows how a dispersion metric can be used to determine the quality of the geolocation data obtained from a global navigation satellite system. The indoor user fitness activities have low quality geolocation data and the outdoor user fitness activities have high quality geolocation data. The dispersion metric successfully classifies the data sets.

All Figures © Under Armour, Inc. 2019. All rights reserved.

### DETAILED DESCRIPTION

Disclosed embodiments include systems, apparatus, methods and storage medium associated with processing data generated by a fitness tracking system, which is also referred to herein as an activity tracking system.

Aspects of the disclosure are disclosed in the accompanying description. Alternate embodiments of the disclosure and their equivalents may be devised without parting from the spirit or scope of the disclosure. It should be noted that any description herein regarding “one embodiment,” “an embodiment,” “an exemplary embodiment,” and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may or may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used with respect to embodiments of the present disclosure, are synonymous.

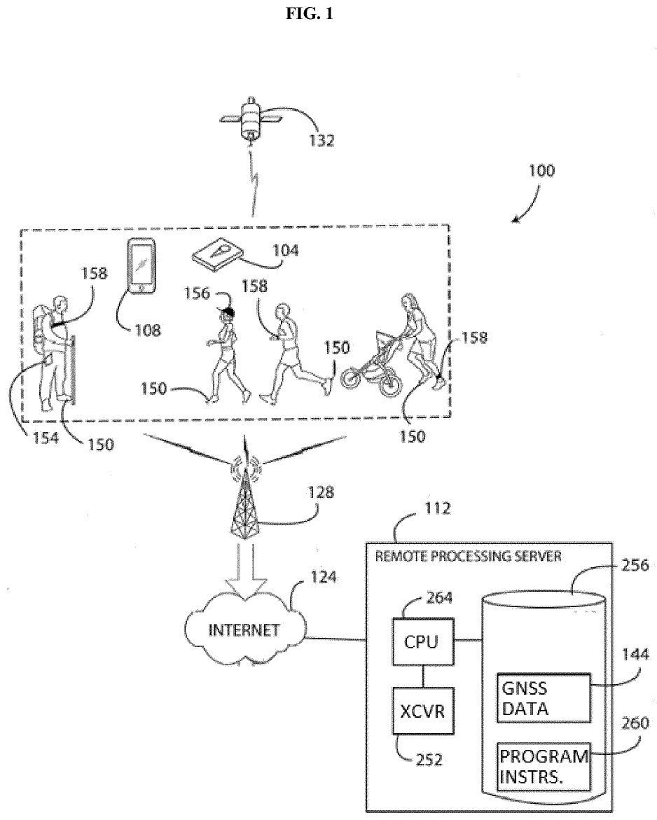

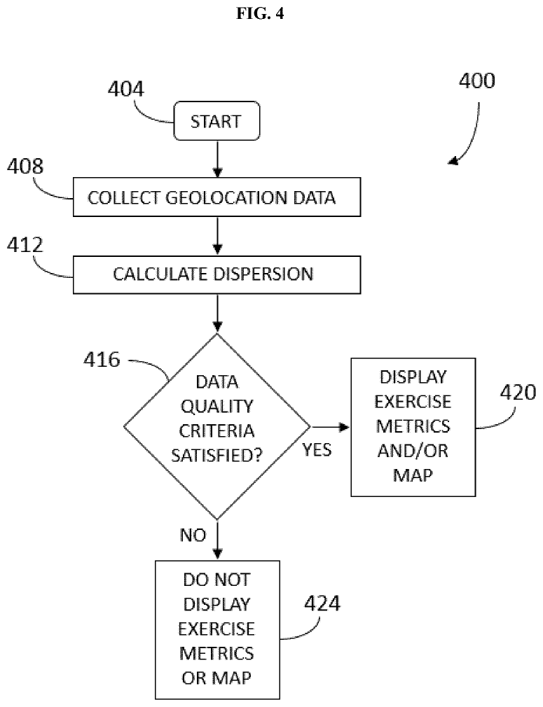

As shown in FIG. 1, a fitness tracking system 100 includes a monitoring device 104, a personal electronic device 108, and a remote processing server 112. The fitness tracking system 100 is configured to transmit and receive data over the Internet 124 using a cellular network 128, for example. The fitness tracking system 100 may also be configured for use with a global navigation satellite system (“GNSS”) 132. Components of the fitness tracking system 100 and a method 400 (FIG. 4) for operating the fitness tracking system 100 are described herein.

The monitoring device 104 is configured to be worn or carried by a user of the fitness tracking system 100. In one embodiment, the monitoring device 104 is permanently embedded in the sole of a shoe 150 worn by the user, such that the monitoring device 104 cannot be removed from the shoe 150 without destroying the shoe 150. The monitoring device 104 may also be configured for placement in the shoe 150, may be attached to the shoe 150, may be carried in a pocket 154 of the user's clothing, may be attached to a hat 156 worn by the user, and/or may be attached to any portion of the user or the user's clothing or accessories (e.g., wrist band, eyeglasses, necklace, visor, etc.). Moreover, in some embodiments, a left monitoring device 104 is located and/or affixed to the user's left shoe 150 and a right monitoring device 104 is located and/or affixed to the user's right shoe 150; both monitoring devices 104 being configured substantially identically.

In other embodiments, the monitoring device 104 includes a strap 158 to mount the monitoring device 104 onto the user. In this embodiment, the monitoring device 104 may be strapped to the user's wrist, arm, ankle, or chest, for example. In at least one embodiment, the strap 158 and the monitoring device 104 are provided as a watch or a watch-like electronic device. In a further embodiment, the monitoring device 104 is included in a heartrate monitoring device (not shown) that is worn around the wrist, chest, or other body location that is typically used to measure heartrate. Thus, the monitoring device 104 is configured for mounting (permanently or removably) on any element of the user or the user's clothing, footwear, or other article of apparel using any of various mounting means such as adhesives, stitching, pockets, or any of various other mounting means. The monitoring device 104 is located proximate to the user during activities and exercise sessions such as hiking, running, jogging, walking, and the like; whereas the personal electronic device 108 may be left behind or remote to the user during an exercise session. In a further embodiment, the components of the monitoring device 104 are included as part of the personal electronic device 108.

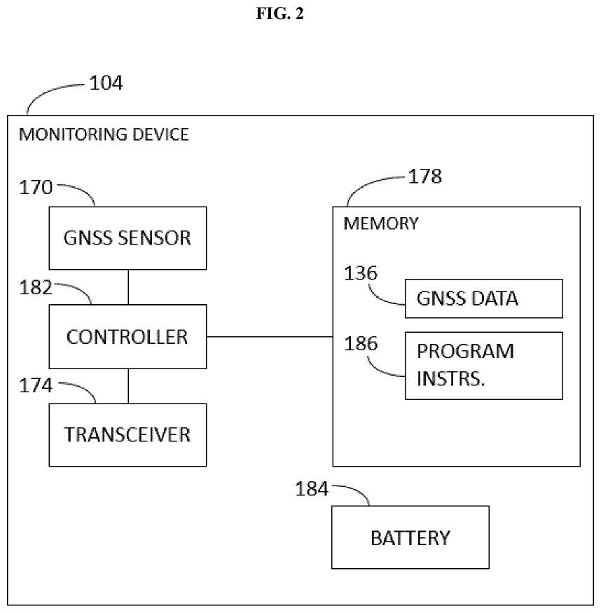

As shown in FIG. 2, the monitoring device 104, which is also referred to herein as a measuring device, a health parameter monitoring device, a distance monitoring device, a speed monitoring device, and/or an activity monitoring device, includes a GNSS sensor 170, a transceiver 174, and a memory 178, each of which is operably connected to a controller 182. The GNSS sensor 170 is configured to collect GNSS data 136, which typically is in the form of geolocation coordinates (e.g. longitude, latitude, and/or elevation). The GNSS data 136 is stored by the controller 182 in the memory 178.

The transceiver 174 of the monitoring device 104, which is also referred to as a wireless transmitter and/or receiver, is configured to transmit and to receive data from the personal electronic device 108. In one embodiment, the transceiver 174 is configured for operation according to the Bluetooth® wireless data transmission standard. In other embodiments, the transceiver 174 comprises any desired transceiver configured to wirelessly transmit and receive data using a protocol including, but not limited to, Near Field Communication (“NFC”), IEEE 802.11, Global System for Mobiles (“GSM”), and Code Division Multiple Access (“CDMA”).

The memory 178 of the monitoring device 104 is an electronic data storage unit, which is also referred to herein as a non-transient computer readable medium. The memory 178 is configured to store the program instruction data 186 and the GNSS data 136 generated by the GNSS sensor 170, as well as any other electronic data associated with the fitness tracking system 100, such as user profile information, for example. The program instruction data 186 includes computer executable instructions for operating the monitoring device 104.

The controller 182 of the monitoring device 104 is configured to execute the program instruction data 186 for controlling the GNSS sensor 170, the transceiver 174, and the memory 178. The controller 182 is provided as a microprocessor, a processor, or any other type of electronic control chip.

The battery 184 is configured to supply the GNSS sensor 170, the transceiver 174, the memory 178, and the controller 182 with electrical energy. In one embodiment, the battery 184 is a button cell battery or a coin cell battery that is permanently embedded in the monitoring device 104 and/or the shoe 150, such that the battery 184 is not user accessible and cannot be replaced or recharged without destroying at least one of the shoe 150 and the monitoring device 104. In another embodiment, the battery 184 is a user-accessible rechargeable lithium polymer battery that is configured to be recharged and/or replaced by the user.

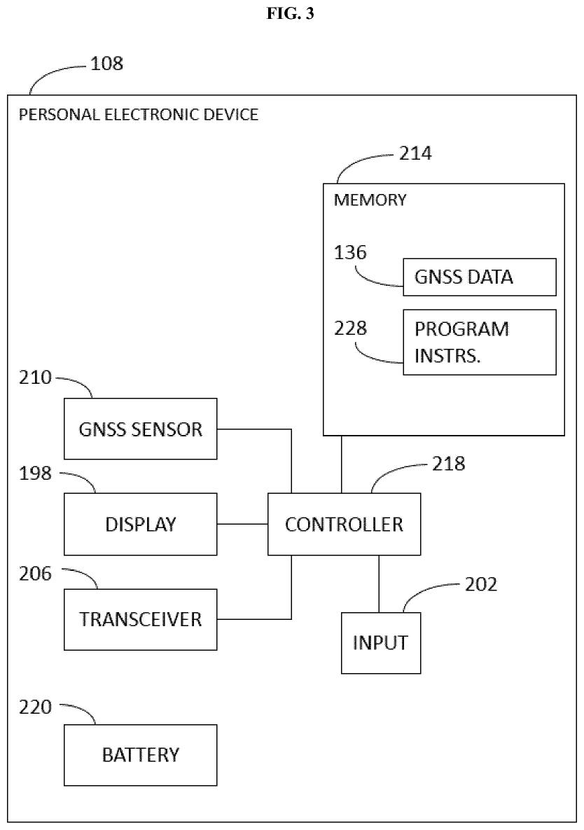

As shown in FIG. 3, the exemplary personal electronic device 108 is configured as a smartphone. In other embodiments, the personal electronic device 108 is provided as a smartwatch, an electronic wristband, or the like. In one embodiment, the personal electronic device 108 is configured to be worn or carried by the user during collection of the GNSS data 136 by the monitoring device 104. In another embodiment, the personal electronic device 108 is not carried or worn by the user during collection of the GNSS data 136, and the personal electronic device 108 receives the GNSS data 136 from the monitoring device 104 after the user completes an exercise session. In a further embodiment, data may be transmitted from the monitoring device 104 to the personal electronic device 108 both during and after completion of an exercise session.

The personal electronic device 108 includes display unit 198, an input unit 202, a transceiver 206, a GNSS sensor 210, and a memory 214 each of which is operably connected to a processor or a controller 218. The display unit 198 may comprise a liquid crystal display (LCD) panel configured to display static and dynamic text, images, and other visually comprehensible data. For example, the display unit 198 is configurable to display one or more interactive interfaces or display screens to the user including a display of at least an estimated distance traversed by the user, a display of an estimated speed of the user, and a display of a map of the user's route. The display unit 198, in another embodiment, is any display unit as desired by those of ordinary skill in the art.

The input unit 202 of the personal electronic device 108 is configured to receive data input via manipulation by a user. The input unit 202 may be configured as a touchscreen applied to the display unit 198 that is configured to enable a user to input data via the touch of a finger and/or a stylus. In another embodiment, the input unit 202 comprises any device configured to receive user inputs, as may be utilized by those of ordinary skill in the art, including e.g., one or more buttons, switches, keys, and/or the like.

With continued reference to FIG. 3, the transceiver 206 of the personal electronic device 108 is configured to wirelessly communicate with the transceiver 174 of the monitoring device 104 and the remote processing server 112. The transceiver 206 wirelessly communicates with the remote processing server 112 either directly or indirectly via the cellular network 128 (FIG. 1), a wireless local area network (“Wi-Fi”), a personal area network, and/or any other wireless network over the Internet 124. Accordingly, the transceiver 206 is compatible with any desired wireless communication standard or protocol including, but not limited to, Near Field Communication (“NFC”), IEEE 802.11, Bluetooth®, Global System for Mobiles (“GSM”), and Code Division Multiple Access (“CDMA”). To this end, the transceiver 206 is configured to wirelessly transmit and receive data from the remote processing server 112, and to wirelessly transmit and receive data from the monitoring device 104.

The GNSS sensor 210 of the personal electronic device 108 is configured to receive GNSS signals from the GNSS 132 (FIG. 1). The GNSS sensor 210 is further configured to generate GNSS data 136 that is representative of a current location on the Earth of the personal electronic device 108 based on the received GNSS signals. The GNSS data 136, in one embodiment, includes latitude and longitude information. In another embodiment, the GNSS data 136 may include elevation data instead of or in addition to the latitude and longitude data. The controller 218 is configured to store the GNSS data 136 generated by the GNSS receiver 210 in the memory 214.

As shown in FIG. 3, the memory 214 of the personal electronic device 108 is an electronic data storage unit, which is also referred to herein as a non-transient computer readable medium. The memory 214 is configured to store electronic data associated with operating the personal electronic device 108 and the monitoring device 104 including all or a subset of the GNSS data 136 and program instruction data 228 including computer executable instructions for operating the personal electronic device.

The controller 218 of the personal electronic device 108 is configured to execute the program instruction data 228 in order to control the display unit 198, the input unit 202, the transceiver 206, the GNSS sensor 210, and the memory 214. The controller 218 is provided as a microprocessor, a processor, or any other type of electronic control chip.

The battery 220 is configured to supply the display unit 198, the input unit 202, the transceiver 206, the GNSS sensor 210, the memory 214, and the controller 218 with electrical energy. In one embodiment, the battery 220 is a rechargeable lithium polymer battery that is configured to be recharged by the user.

As shown in FIG. 1, the remote processing server 112 is remotely located from the monitoring device 104 and the personal electronic device 108. The server 112 is located at a server physical location and the personal electric device 108 and the monitoring device 104 are located at one or more other physical locations that are different from the server physical location.

The server 112 includes a transceiver 252 and a memory 256 storing at least a portion of the GNSS data 144 and program instructions 260. Each of the transceiver 252 and the memory 256 is operably connected to a central processing unit (“CPU”) 264.

The transceiver 252 of the remote processing server 112 is configured to wirelessly communicate with the personal electronic device 108 either directly or indirectly via the cellular network 128, a wireless local area network (“Wi-Fi”), a personal area network, and/or any other wireless network. Accordingly, the transceiver 252 is compatible with any desired wireless communication standard or protocol including, but not limited to, Near Field Communication (“NFC”), IEEE 802.11, Bluetooth®, Global System for Mobiles (“GSM”), and Code Division Multiple Access (“CDMA”).

The CPU 264 of the remote processing server 112 is configured to execute the program instruction data 260 by applying, for example, the set of rules to the GNSS data 144. The rules of the set of rules are categorized as mathematical operations, event-specific operations, and processed signals. The CPU 264 is provided as a microprocessor, a processor, or any other type of electronic control chip. Typically, the CPU 264 is more powerful than the controller 218 of the personal electronic device 108 and the controller 182 of the monitoring device 104, thereby enabling the remote processing server 112 to make calculations more quickly than the devices 104, 108. In some embodiments of the fitness tracking system 100 the remote processing server 112 is not included and/or is not used.

As shown in the flowchart of FIG. 4, the fitness tracking system 100 is configured to execute a method 400 for automatically determining the data quality of geolocation data, and based on that quality to make a determination of whether to display exercise metrics such as speed and distance and/or to display of a map of the location of fitness activity to the user of the fitness tracking system. When the quality of the geolocation data is high, there will be a high degree of confidence in the calculations for the exercise metrics derived from the geolocation data, and there will also be a high degree of confidence associated with the map displayed showing the locations of fitness activity. However, when the quality of the geolocation data is low, then the confidence in the calculations for the exercise metrics derived from the geolocation data will be low, and there will also be a low degree of confidence associated with the map displayed showing the locations of fitness activity.

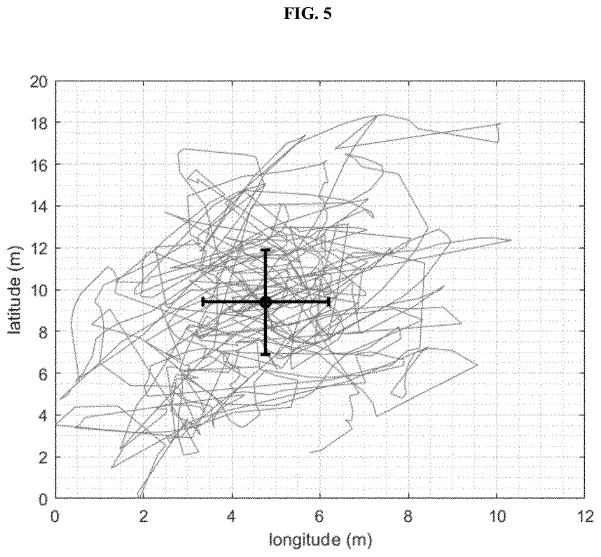

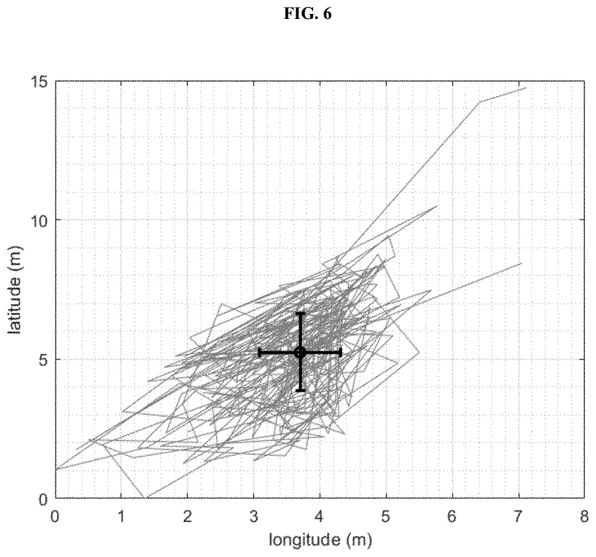

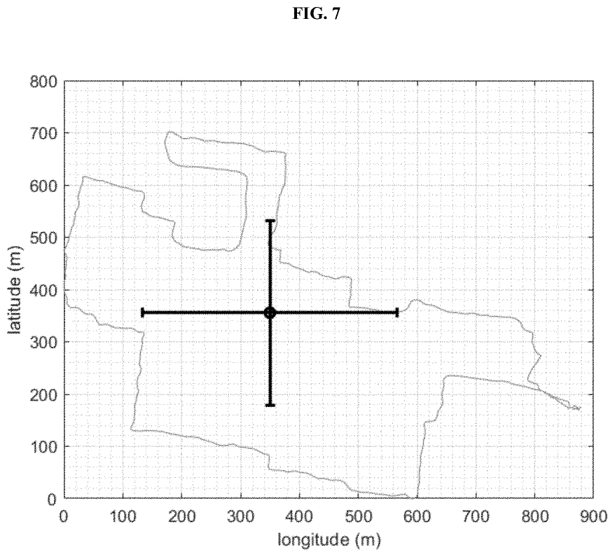

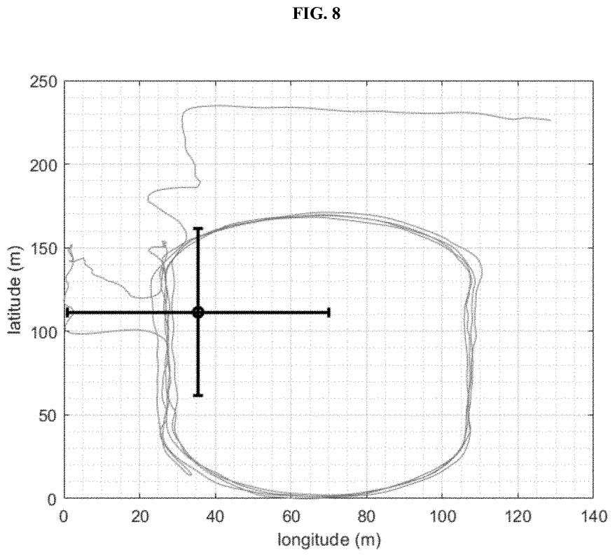

During typical operation of the fitness tracking system 100, the user will start the workout (404) and collect geolocation data (408). The quality of the geolocation data obtained by a fitness tracking system during a user fitness activity is typically related to the type of user fitness activity. Exemplary embodiments of user fitness activities that tend to obtain high quality geolocation data include outdoor walking, outdoor running, and outdoor cycling (see FIG. 7 and FIG. 8). In fact, most user fitness activities that take place outdoors will have geolocation data that is of an acceptable quality level. Exemplary embodiments of user fitness activities that tend to obtain low quality geolocation data include walking on a treadmill, running on a treadmill, elliptical workouts, weightlifting, and stationary bicycle workouts (see FIG. 5 and FIG. 6). Indeed, most user fitness activities that take place indoors will have geolocation data that is of an unacceptable quality level. Other exemplary embodiment of user activities that tend to obtain low quality geolocation data include user errors. One such embodiment occurs when the user accidently starts a workout session on the fitness tracking system and obtains geolocation data when, in fact, no workout session is actually being performed by the user. Instead, the user, after accidently starting a workout on the fitness tracking system, may move around their house or office in a slow ambulatory manner or leave the fitness tracking system in a stationary location such as a chair, table, or desk. In these cases of user error, the quality of the geolocation data obtained by the fitness tracking system will be low.

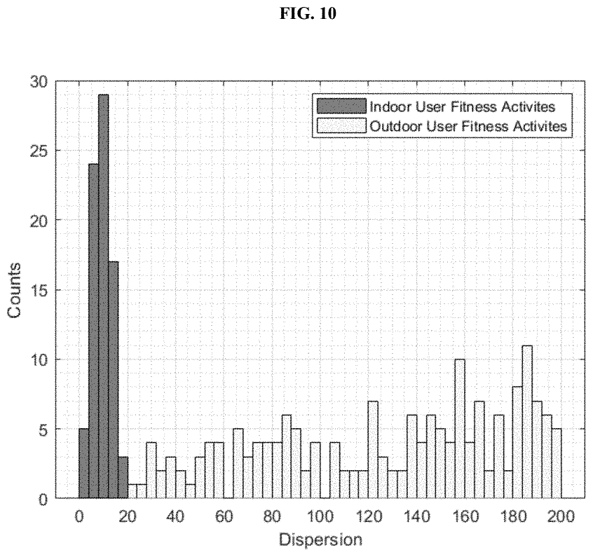

The quality of the geolocation data obtained during a user fitness activity may be determined by a method 412 that analyzes the dispersion of the geolocation coordinates (e.g. longitude, latitude, and/or elevation) received during the user fitness activity. The dispersion of a data set describes the scatter or spread of the data distribution. Dispersion may be quantified through various different calculations. These calculations include, but are not limited to, standard deviation, interquartile range, range, mean absolute difference, median absolute deviation, and average absolute deviation. Higher amounts of dispersion in the geolocation coordinate data increase the confidence in the quality of the geolocation data, while lower amounts of dispersion in the geolocation coordinate data decrease the confidence in the quality of the geolocation (see FIG. 10).

A data quality criteria 416 may be established from the dispersion analysis. This data quality criteria may include a single dispersion metric or a combination of dispersion metrics to assess the quality of the geolocation data obtained during a user fitness activity. In some embodiments of this invention, a machine learning model such as a support vector machine or random forest may be used in the data quality determination process. If the data quality satisfies the data quality criteria, then the geolocation data may be used to calculate exercise metrics such as speed and distance and/or to display a map showing the locations of fitness activity (420). However, if the data quality does not satisfy the data quality criteria, then the geolocation data will not be utilized to calculate exercise metrics, and a map showing the locations of fitness activity will not be shown (424).

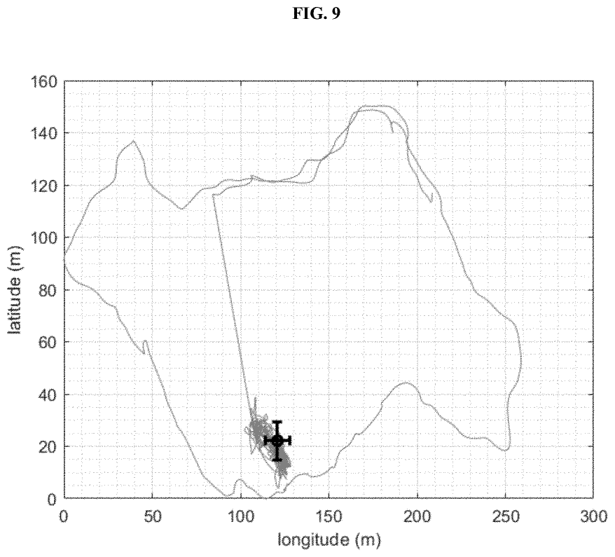

In an exemplary embodiment of this disclosure, the data quality determination would be made following the conclusion of a user fitness activity. However, in another exemplary embodiment, the data quality determinations could be assessed in real-time throughout the user fitness activity. Additionally, in another exemplary embodiment of this disclosure, the data quality for the user fitness activity as a whole entity would be determined. However, in another exemplary embodiment, the data quality of multiple subsections would be determined within the user fitness activity (see FIG. 9). When multiple subsections are being considered, a method to determine the cutoff points between the different subsections may consider the speed calculated from the geolocation data. A speed threshold may be used to divide the data into subsections.

As described in this disclosure, an exemplary embodiment of this invention obtains geolocation data from a GNSS. Other exemplary embodiments of this invention may obtain geolocation data from a Wi-Fi positioning system or through cell tower triangulation. Further exemplary embodiment of this invention may obtain geolocation data from a hybrid system that includes a combination of global navigation satellite system data, a Wi-Fi positioning system, and/or cell tower triangulation.

What is claimed is:

1. A method for determining the quality of geolocation data, said method comprising:
receiving at a server apparatus geolocation data from a mobile apparatus;
calculating the dispersion of said geolocation data;
evaluating said dispersion against a data quality criteria;
when said criteria is met, using said data to calculate one or more activity metrics and/or to generate a map showing the locations of user activity;
when said criteria is not met, omitting to use said data to calculate one or more activity metrics; and
when said criteria is not met, omitting to use said data to generate a map showing the location of user activity.

2. The method of claim 1, wherein said geolocation data is obtained from a global navigation satellite system.

3. The method of claim 1, wherein said geolocation data is obtained from a Wi-Fi positioning system or through cell tower triangulation.

4. The method of claim 1, wherein said geolocation data is obtained from a hybrid method that uses a combination of global navigation satellite system data, a Wi-Fi positioning system, and/or cell tower triangulation.

5. The method of claim 1, wherein said geolocation data is obtained by said mobile apparatus from a second mobile apparatus device.

6. The method of claim 1, wherein said one or more activity metrics comprises speed and/or distance.

7. The method of claim 1, wherein when said criteria is not met, calculating said one or more activity metrics using data from a secondary source.

8. The method of claim 1, wherein the dispersion of the data is calculated as the standard deviation, interquartile range, range, mean absolute difference, median absolute deviation, or average absolute deviation of the geolocation data.

9. A method for determining the quality of geolocation data, said method comprising:
receiving at a personal electronic device geolocation data from a mobile apparatus;
calculating the dispersion of said geolocation data;
evaluating said dispersion against a data quality criteria;
when said criteria is met, using said data to calculate one or more activity metrics and/or to generate a map showing the locations of user activity;
when said criteria is not met, omitting to use said data to calculate one or more activity metrics; and
when said criteria is not met, omitting to use said data to generate a map showing the location of user activity.

10. The method of claim 9, wherein said geolocation data is obtained from a global navigation satellite system.

11. The method of claim 9, wherein said geolocation data is obtained from a Wi-Fi positioning system or through cell tower triangulation.

12. The method of claim 9, wherein said geolocation data is obtained from a hybrid method that uses a combination of global navigation satellite system data, a Wi-Fi positioning system, and/or cell tower triangulation.

13. The method of claim 9, wherein said geolocation data is obtained by said mobile apparatus from a second mobile apparatus device.

14. The method of claim 9, wherein said one or more activity metrics comprises speed and/or distance.

15. The method of claim 9, wherein when said criteria is not met, calculating said one or more activity metrics using data from a secondary source.

16. The method of claim 9, wherein the dispersion of the data is calculated as the standard deviation, interquartile range, range, mean absolute difference, median absolute deviation, or average absolute deviation of the geolocation data.

17. A server apparatus comprising:
an interface for communicating with a mobile device;
a processor configured to execute one of more instructions which are configured to when executed:
calculate a dispersion of said geolocation data;
evaluate said dispersion against a data quality criteria;
when said criteria is met, using said data to calculate one or more activity metrics and/or to generate a map showing the locations of user activity;
when said criteria is not met, omitting to use said data to calculate one or more activity metrics; and
when said criteria is not met, omitting to use said data to generate a map showing the location of user activity.
